(19) United States
(12) Patent Application Publication
(10) Pub. No.: US 2023/0032815 A1
(43) Pub. Date: Feb. 2, 2023

(54) PRINT CARRIAGE MOVEMENT CONTROL

(71) Applicant: Hewlett-Packard Development Company, L.P., Spring, TX (US)

(72) Inventors: Wei Lit Teoh, Singapore (SG); Kian Yaw Eugene Goh, Singapore (SG); Narayanasamy Periyasamy, Corvallis, OR (US)

(21) Appl. No.: 17/789,615

(22) PCT Filed: Mar. 23, 2020
(86) PCT No.: PCT/US2020/024202

§ 371 Date: Jun. 28, 2022

(51) Int. Cl. B41J 2/175

(52) U.S. Cl. CPC B41J 2/17546

(57) ABSTRACT

Example techniques for controlling a movement of a print carriage are described. In an example, in response to a determination that a movement of the print carriage in a printing device may be an unstable movement, a first movement parameter value may be associated with the movement of the print carriage, to prevent the unstable movement.

### BACKGROUND

A printing device may be used for printing an image, a document, or the like on a printable medium, such as a sheet of paper, fed to the printing device. The printing device may include a print cartridge for dispensing fluid, such as ink, on the printable medium for printing purposes. The printing device may also include a print carriage for housing the print cartridge. The print carriage may be moved for moving the print cartridge over various regions of the printable medium to facilitate dispensing of fluid on various locations of the printable medium for the printing.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1 illustrates a printing device in which an unstable movement of a carriage unit is to be prevented, according to an example implementation of the present subject matter;

FIG. 2 illustrates a printing device in which a likely unstable movement of a carriage unit is determined based on a plurality of conditions, according to an example implementation of the present subject matter;

FIG. 3 illustrates a printing device having a print carriage slidably mounted on a carriage rod, according to an example implementation of the present subject matter;

FIG. 4 illustrates a perspective view of a printing device, according to an example implementation of the present subject matter;

FIG. 5 illustrates a side view of a carriage unit, according to an example implementation of the present subject matter;

FIG. 6 illustrates a schematic view of a printing device, according to an example implementation of the present subject matter; and

FIG. 7 illustrates a print carriage having different angular orientations relative to a carriage rod, according to an example implementation of the present subject matter.

### DETAILED DESCRIPTION

A print carriage may be moved in a printing device to facilitate printing on various regions of a printable medium. To facilitate the movement of the print carriage, the print carriage may be slidably mounted on a supporting member and may slide along the supporting member. Sometimes, the movement of the print carriage in the printing device may be an unstable movement. For example, the print carriage may undergo vibrations while sliding on the supporting member. The instability of the print carriage may be due to various reasons.

In an example, instability may be caused if a size of a print cartridge, also referred to as a cartridge, disposed on the print carriage is larger than a size that can be supported by the supporting member. A larger size, such as a longer length, of the cartridge causes a center of gravity of the print carriage to move away from the supporting member. The movement of the center of gravity increases a moment of force experienced by bearings that support the print carriage on the supporting member. The instability may increase with a reduction in the weight of the cartridges, as the reduction in the weight reduces a contact force exerted by the bearings. The reduction in the weight of the cartridges may be caused by the dispensing of ink by the cartridges.

In another example, instability of the print carriage may be caused due to vibrations of the print carriage induced by cogging of a carriage motor that drives the print carriage. The vibrations may increase in amplitude for a lower weight of the cartridges or due to the absence of cartridges on the print carriage. The print carriage may be moved in the printing device in the absence of cartridges, for example, when the printing device is newly installed at the premises of a user and is tested for proper functioning.

Further, in an example, instability may be caused when a position of the print carriage relative to a backbone member of the printing device is raised, as the raising may change the orientation of the print carriage relative to the supporting member and may give rise to an imbalance in the forces and moments acting on the print carriage. The position of the print carriage may be raised relative to the backbone member to maintain a substantially constant clearance between the cartridge and a top surface of the printable medium to be printed on, regardless of the thickness of the printable medium.

The instability of the print carriage may cause a reduction in the quality of a print job, as the ink may get sprayed on the printable medium due to the vibrations. The instability may also cause damage to the bearings.

The present subject matter relates to print carriage movement control in a printing device. However, in other examples, various aspects of the described subject matter may be applied to other applications having an object slidably mounted on a supporting member and may slide along the supporting member With the implementations of the present subject matter, stability of a print carriage can be ensured regardless of various parameters associated with the print carriage and the cartridge, such as the size of the cartridge, the mass of the cartridge, and the position of the print carriage relative to the backbone member.

In accordance with an example implementation of the present subject matter, a printing device including a carriage unit is described. The carriage unit includes a print carriage and may also include a cartridge disposed on the print carriage. In an example, the carriage unit may be movably mounted on a supporting member to allow the carriage member to move in the printing device. The supporting member may be a rod and may be referred to as a carriage rod.

The printing device includes a controller that can determine if a movement of the carriage unit in the printing device is likely to be an unstable movement. Such a determination may be performed, for example, based on an amount of fluid, such as ink, in the cartridge. For instance, if the amount of fluid in the cartridge is less than a threshold amount, the controller may determine that the movement is likely to be an unstable one. A less amount of the fluid may cause a reduced weight of the carriage unit. The reduced weight, in turn, causes a reduced amount of contact force to be exerted on the carriage unit by bearings that support the carriage unit on the supporting member. Further, in an example, the controller may determine that the movement is likely to be unstable in response to the absence of the cartridge on the print carriage, as the absence of the cartridge implies a reduced weight of the carriage unit.

The instability in the movement may also be determined based on an orientation of the carriage unit relative to the supporting member. For instance, if the carriage unit is at an inclined position relative to the supporting member, the controller may determine that the movement is likely to be unstable.

If the controller detects existence of a condition that is likely to cause an unstable movement, such as the absence of the cartridge on the print carriage or the amount of fluid being less than the threshold amount, the controller may determine that a first movement parameter value is to be associated with a movement of the carriage unit. In an example, the first movement parameter value may be a first acceleration value. Accordingly, an acceleration of the carriage unit may be set at the first acceleration value. The first acceleration value may be less than an acceleration value that is set if no instability-causing conditions are detected. Therefore, the acceleration value is reduced to ensure a stable movement of the carriage unit.

In an example, the first movement parameter value may be a first value of a correction factor, also referred to as a first correction factor value. The correction factor may correspond to a control system that controls the movement of the carriage unit. In an example, the control system may control movement of a carriage motor that drives the carriage unit and may include a proportional-integral-derivative (PID) controller. Further, the correction factor value may be a proportional gain value, an integral gain value, or a derivative gain value of the control system.

The present subject matter controls a movement of print carriage to provide a stable movement of a print carriage in a printing device. The stable movement of the print carriage results in an improved print quality. The present subject matter also reduces the noise generated by the printing device during its operation, as vibrations of the print carriage are prevented. Therefore, acoustics of the printing device are improved. The present subject matter prevents the use of additional or more expensive components to cause a stable movement of the print carriage. Therefore, a stable movement of the print carriage can be achieved in a simple and a cost-effective manner.

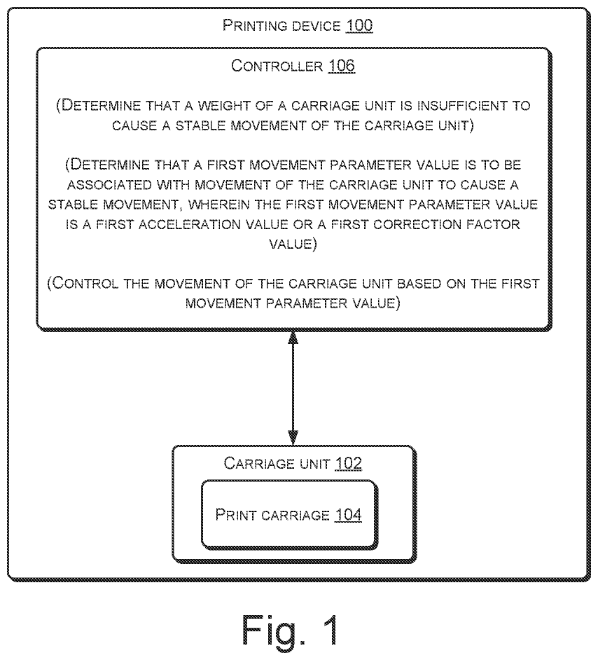

The present subject matter is further described with reference to FIGS. 1-7. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

Further, in the description provided below, the present subject matter is explained with reference to printing devices in which print carriage is supported on a carriage rod and slides along the carriage rod. However, the present subject matter can be utilized in printing devices where other types of supporting members, such as a linear bearing, are used for supporting the print carriage.

FIG. 1 illustrates a printing device 100 in which an unstable movement of a carriage unit 102 is to be prevented, according to an example implementation of the present subject matter. The carriage unit 102 includes a print carriage 104, which can house a print cartridge (not shown in FIG. 1), also referred to as a cartridge. The cartridge, if present on the print carriage 104, may also be a part of the carriage unit 102. The carriage unit 102 may be movably mounted in the printing device 100. For instance, the print carriage 104 may move in the printing device 100 by sliding on a supporting member (not shown in FIG. 1) of the printing device 100. In the below description, the terms “movement of the print carriage” and “movement of the carriage unit” are used interchangeably.

The printing device 100 may also include a controller 106 to determine if the movement of the carriage unit 102 is likely to be an unstable movement. An unstable movement may refer to a movement in which the carriage unit 102 undergoes a vibration in any of a length direction, a breadth direction, or a height direction of the printing device 100. The controller 106 may be a processing resource capable of executing machine-readable instructions. In an example, the controller 106 may be implemented as or may be part of a printed circuit assembly (PCA) (not shown in FIG. 1) of the printing device 100. The PCA may control the operation of the print carriage 104 or may control overall operation of the printing device 100. The PCA controlling operation of the print carriage 104 may be referred to as carriage PCA and the PCA controlling overall operation of the printing device 100 may be referred to as a central PCA.

The controller 106 may determine that a weight of the carriage unit 102 is insufficient to cause a stable movement of the carriage unit 102 in the printing device 100. A reduced weight of the carriage unit 102 may make the carriage unit 102 more susceptible to vibrations during its movement in the printing device 100. For example, if the carriage unit 102 is movably supported on the supporting member, the reduced weight of the carriage unit 102 causes a reduced amount of contact force to be exerted on the carriage unit 102, which reduces stability of the carriage unit 102. In an example, the controller 106 may detect the insufficiency of weight based on an absence of the cartridge in the carriage unit 102. In another example, the controller 106 may detect the insufficiency of weight if a reduced amount of fluid, such as an amount of fluid less than a threshold amount, is present in the cartridge. The fluid in the cartridge may be, for example, ink.

In response to the detection of the weight insufficiency, the controller 106 may determine that a first movement parameter value is to be associated with the movement of the carriage unit 102, to cause the stable movement of the carriage unit 102. The first movement parameter value may refer to a first value of a movement parameter associated with the movement of the carriage unit 102. In an example, the movement parameter may be acceleration, and the first movement parameter value is a first acceleration value. In another example, the movement parameter may be a correction factor and the first movement parameter value is a first correction factor value. The correction factor may be associated with a control system (not shown in FIG. 1) that controls the movement of the carriage unit 102. The control system may include, for example, a proportional-integral-derivative (PO) controller and the first correction factor value may be a first value of a derivative gain of the PID controller. The first value of the derivative gain may also be referred to as a first derivative gain value. In an example, in response to the detection of the weight insufficiency, the controller 106 may determine that both the first acceleration value and the first derivative gain value are to be associated with the movement of the carriage unit 102.

The controller 106 may then control the movement of the carriage unit 102 based on the first movement parameter value. For example, for a subsequent movement of the carriage unit 102 in the printing device 100, the controller 106 may control acceleration of the carriage unit 102 such that the acceleration equals the first acceleration value. If the first movement parameter value is the first derivative gain value, the controller 106 may control the derivative gain of the control system to equal the first derivative gain value. In an example, the controller 106 may control the movement of the carriage unit 102 based on both the first acceleration value and the first derivative gain value.

In an example, the controller 106 may perform its functions explained herein by executing machine-readable instructions stored in a memory (not shown in FIG. 1) of the printing device 100, The memory may include any non-transitory computer-readable medium including, for example, volatile memory, such as RAM, or non-volatile memory such as EPROM, flash memory, or the like.

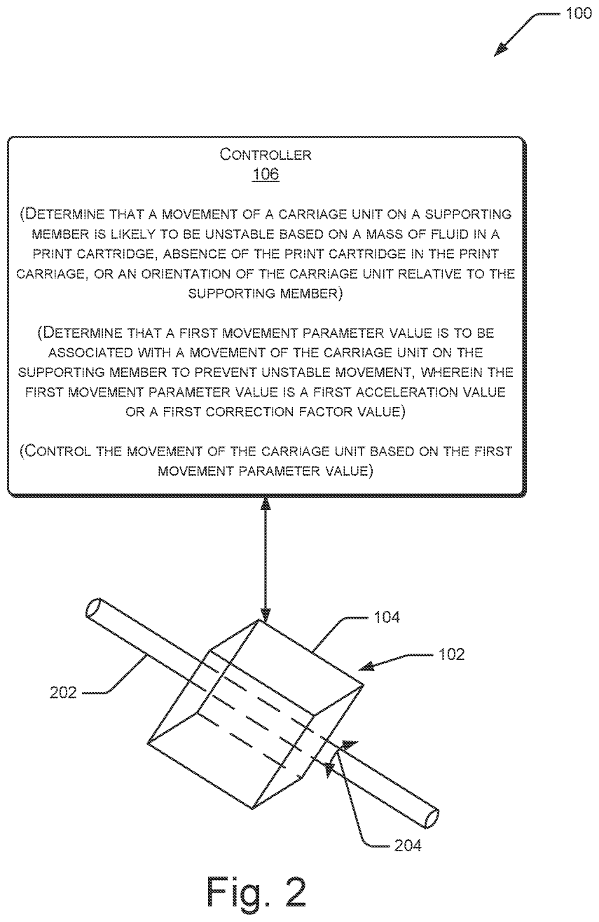

FIG. 2 illustrates the printing device 100 in which a likely unstable movement of the carriage unit 102 is determined based on a plurality of conditions, according to an example implementation of the present subject matter. The carriage unit 102 may be movably mounted on a supporting member 202. For instance, the print carriage 104 of the carriage unit 102 may slide along a length of the supporting member 202. In addition, in an example, the carriage unit 102 may undergo slight rotations (e.g., 5°-10°) about the supporting member 202, for example, in a direction 204. The rotation may facilitate varying a spacing between the cartridge (not shown in FIG. 2) on the print carriage 104 and a printable medium (not shown in FIG. 2), as will be explained later. The rotation may cause a change in an orientation of the carriage unit 102 relative to the supporting member 202.

The controller 106 may determine that a movement of the carriage unit 102 on the supporting member 202 is likely to be an unstable one based on a mass of fluid in the cartridge, the absence of the cartridge in the carriage unit 102, an orientation of the carriage unit 102 relative to the supporting member 202, or any combinations thereof. The mass of fluid in the cartridge and the presence/absence of the cartridge in the carriage unit 102 may determine the amount of contact force exerted on the carriage unit 102. As explained earlier, the amount of contact force determines the stability of the carriage unit 102. The mass of the fluid in the cartridge may be determined based on an amount of fluid in the cartridge. In an example, in addition to the mass of the cartridge, a size of the cartridge may also be utilized to determine whether the movement of the carriage unit 102 is likely to be unstable, as the size of the cartridge may dictate a position of the center of gravity of the carriage unit 102. A larger size, such as a longer length, of the cartridge may cause the center of gravity of the carriage unit 102 to move away from the supporting member 202. The movement of the center of gravity may, in turn, increase a moment of force experienced by bearings (not shown in FIG. 2) that support the carriage unit 102 on the supporting member 202.

An orientation of the carriage unit 102 relative to the supporting member 202 dictates a moment of force acting on the carriage unit 102. For instance, a moment of force experienced by the carriage unit 102 when the carriage unit 102 is aligned with the supporting member 202 may be different than that experienced when the carriage unit 102 is inclined relative to the supporting member 202. In an example, the orientation of the carriage unit 102 relative to the supporting member 202 may be determined based on a position of the carriage unit 102 relative to a backbone member (not shown in FIG. 2). The backbone member may be disposed parallel to the supporting member 202 and may support the print carriage 104 on the supporting member 202. To support the print carriage 104, the backbone member may be coupled to the print carriage 104 through one of a plurality of backbone contacts (not shown in FIG. 2) of the print carriage 104. The backbone contact through which the backbone member is coupled to the print carriage 104 may determine a position of the print carriage 104 (and the carriage unit 102) relative to the backbone member and the orientation of the print carriage 104 (and the carriage unit 102) relative to the supporting member 202.

In response to the determination of a likely unstable movement, the controller 106 may determine that the first movement parameter value is to be associated with the movement of the carriage unit 102 on the supporting member 202, to prevent the unstable movement. Further, the controller 106 may control the movement of the carriage unit 102 based on the first movement parameter value. For instance, the controller 106 may control the acceleration of the carriage unit 102 to equal the first acceleration value, may control the derivative gain of the control system to equal the first derivative gain value, or both.

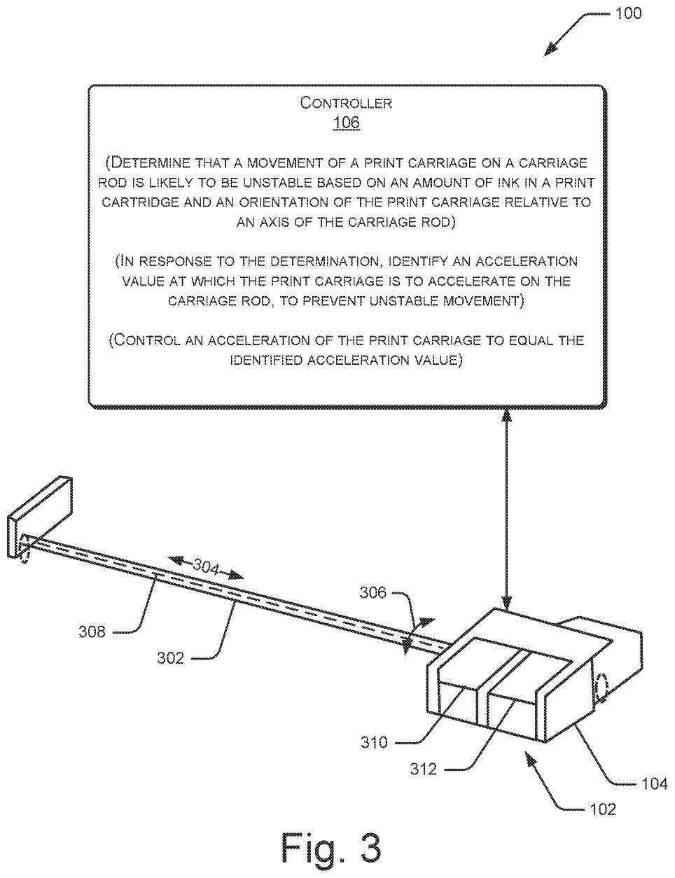

FIG. 3 illustrates the printing device 100 having the print carriage 104 slidably mounted on a carriage rod 302, according to an example implementation of the present subject matter. The carriage rod 302 may correspond to the supporting member 202. The print carriage 104 may slide along a length of the carriage rod 302, such as in a direction 304. Further, the print carriage 104 may undergo a slight rotation about the carriage rod 302 in a direction 306. Such a rotation may cause a change in the orientation of the print carriage 104 relative to an axis 308 of the carriage rod 302, also referred to as the carriage axis 308. The rotation may also cause an adjustment of a cartridge-to-printable medium spacing.

The print carriage 104 may house cartridges 310 and 312. A cartridge may be a fluid-jet precision-dispensing device or a fluid ejector structure that precisely dispenses fluid, such as ink and liquid toner, on a printable medium, such as a sheet of paper. Hereinafter, the fluid dispensed by the cartridge is explained as ink, for the ease of explanation. The cartridge may be a single-color, such as black, ink cartridge or a multi-color cartridge. For instance, the cartridge 310 may be a black-ink cartridge and the cartridge 312 may be a multi-color cartridge. A cartridge may include a fluid ejection die (not shown in FIG. 3) that ejects drops of fluid stored in the cartridge through orifices or nozzles (not shown in FIG. 3) toward the printable medium to print onto the printable medium. The fluid ejection die may be, for example, a print head, such as a thermal inkjet (TIJ) print head or a piezoelectric inkjet print head. Although two cartridges are shown as being disposed on the print carriage 104, in other examples, less or more number of cartridges may be disposed on the print carriage 104.

The controller 106 may determine that the movement of the print carriage 104 on the carriage rod 302 is likely to be unstable based on an amount of ink in a cartridge, such as the cartridge 310 or the cartridge 312, an orientation of the print carriage 104 relative to the carriage axis 308, or both. In an example, instead of, or in addition to, the amount of ink in the cartridge, a size of a cartridge may be utilized to determine that the movement of the print carriage 104 is likely to be unstable. In response to the determination, the controller 106 may also identify an acceleration value at which the print carriage 104 is to accelerate on the carriage rod 302. Subsequently, the controller 106 may control the acceleration of the print carriage 104 such that the acceleration equals the identified acceleration value. In an example, the acceleration value identified for an ink amount less than the threshold amount may be different from that identified for an inclined orientation of the carriage unit 102. However, in the explanation herein, the acceleration value at which the carriage unit 102 is operated to prevent unstable movement is referred to as the first acceleration value regardless of the instability-causing condition.

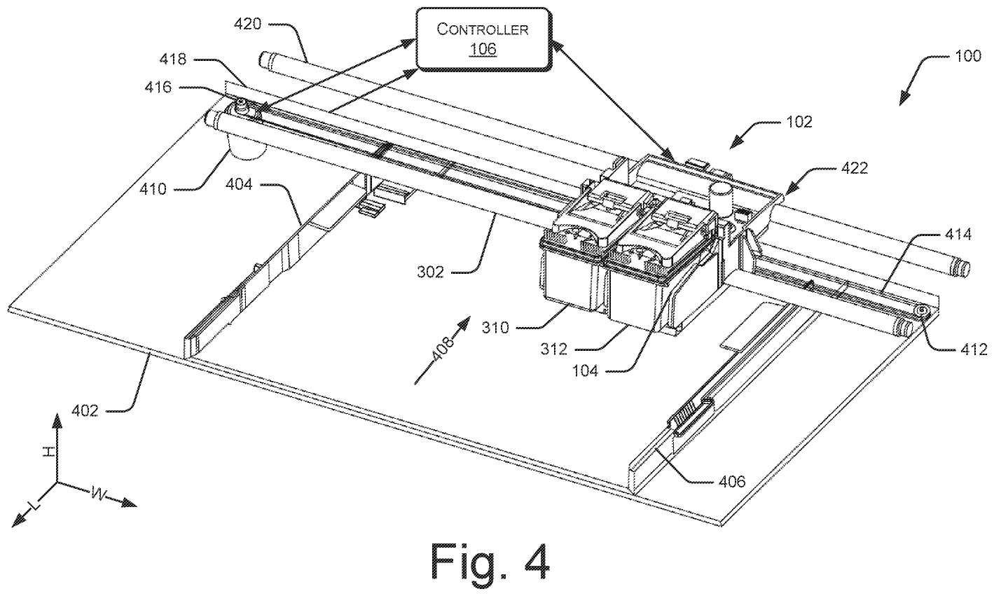

FIG. 4 illustrates a perspective view of the printing device 100, according to an example implementation of the present subject matter. Here, various components of the printing device 100, such as outer cover, chassis, and feed roller, have been obscured to clearly illustrate the carriage rod 302, the print carriage 104, the cartridges 310 and 312, and other components coupled to them.

The printing device 100 includes a media tray 402 on which a printable medium (not shown in FIG. 4) to be printed on may be placed. The printing device 100 may also include adjuster legs 404 and 406 which can be adjusted in position on the media tray 402 to be placed adjacent to sides of the printable media. The printable media placed on the media tray 402 may be conveyed inside the body of the printing device 100 in a direction 408. Subsequently, the printable medium may move upwards in a height direction ‘1-1’ of the printing device 100 by moving around a roller (not shown in FIG. 4) and may be placed below the carriage rod 302. The carriage rod 302 may extend in length along a width direction ‘W’ of the printing device 100, as illustrated.

The printing device 400 may also include the print carriage 104. In an example, the print carriage 104 may be a frame-like structure and may have stalls in which cartridges may be received and supported. For instance, the print carriage 104 may include a first stall in which the cartridge 310 is supported and a second stall in which the cartridge 312 may be supported.

The print carriage 104 may be mounted on the carriage rod 302 and may slide along the length of the carriage rod 302. To facilitate the movement of the print carriage 104 along the carriage rod 302, the printing device 100 may include a motor 410, which may be referred to as the carriage motor 410. The carriage motor 410 may be provided near one end of the carriage rod 302. Further, near the other end of the carriage rod 302, a pulley 412 may be provided. An endless belt 414 may be coupled to an output shaft 416 of the carriage motor 410 and the pulley 412. Accordingly, the endless belt 414 may travel around the output shaft 416 and the pulley 412 when the carriage motor 410 rotates. The endless belt 414 may also be coupled to the print carriage 104. Therefore, when the endless belt 414 travels around the output shaft 416 and the pulley 412, the print carriage 104 slides along the carriage rod 302.

The printing device 100 may also include an encoder strip 418 to facilitate determination of a position of the print carriage 104 on the carriage rod 302. The encoder strip 418 may run parallel to the carriage rod 302. Further, a portion of the print carriage 104 extends rearwardly and over the encoder strip 418. The encoder strip 418 may include graduations, which may be in the form of opaque lines marked on the encoder strip 418. Such graduations may be optically sensed, for example, by the controller 106 to determine the position of the print carriage 104. The position of the print carriage 104 may be utilized to determine and control the speed and the acceleration of the print carriage 104 by the control system (not shown in FIG. 4).

The printing device 100 may further include a backbone member 420. The backbone member 420 may provide structural support to components of the printing device 100, such as the print carriage 104. The backbone member 420 may be, for example, a rail made of sheet metal. In an example, the backbone member 420 may be disposed parallel to the carriage rod 302 and may have a substantially equal length as the carriage rod 302. Further, the backbone member 420 may be disposed behind the carriage rod 302 in a length direction ‘L’ of the printing device 100. The print carriage 104 may extend in a rearward direction from the carriage rod 302 and may be supported on the backbone member 420. For instance, an end 422 of the print carriage 104 may be coupled to the backbone member 420 to support the print carriage 104 on the carriage rod 302. The end 422 may be referred to as a rear-side of the print carriage 104. In an example, the end 422 may include a plurality of backbone contacts (not shown in FIG. 4) distributed in the height direction ‘H’, and the end 422 may be coupled to the backbone member 420 through one of the plurality of backbone contacts. The backbone contact through which the end 422 is coupled to the backbone member 420 may determine the orientation of the print carriage 104 relative to the carriage axis 308 (not shown in FIG. 4). The orientation of the print carriage 104 relative to the carriage axis 308 may be adjusted to vary a clearance between a cartridge and the printable medium on which the cartridge is to dispense ink. The orientation of the print carriage 104 relative to the carriage axis 308 may also be referred to as orientation of the print carriage 104 relative to the carriage rod 302 and as orientation of the carriage unit 102 relative to the carriage axis 308.

The print carriage 104 may undergo an unstable movement on carriage rod 302 due to various reasons, such as a reduced weight of the carriage unit 102 or an inclined orientation of the print carriage 104 relative to the carriage rod 302. To prevent the unstable movement, the controller 106 may monitor for the existence of instability-causing conditions, i.e., conditions that may lead to the unstable movement. The instability-causing conditions may include, for example, the absence of a cartridge in the print carriage 104, an amount of ink in the cartridge being less than a threshold amount, and the print carriage 104 being unaligned, such as inclined at a non-zero degree angle, relative to the carriage rod 302.

For instance, the controller 106 may detect whether a cartridge is present on the print carriage 104, may monitor the amount of ink in the cartridges 310 and 312, and may monitor the backbone contact that is in contact with the backbone member 42a If, based on the monitoring, the controller 106 determines that there exists a condition that may lead to an unstable movement, the controller 106 may determine that the first movement parameter value is to be associated with the movement of the print carriage 104. Thereafter, when the print carriage 104 starts moving on the carriage rod 302, for example, in response to receipt of a print job, the controller 106 may associate the first movement parameter value with the movement of the print carriage 104. Thus, the controller 106 preempts the occurrence of an unstable movement before movement of the print carriage 104 and accordingly controls the movement. In this manner, the controller 106 ensures that the movement of the print carriage 104 is always stable.

In an example, the first movement parameter that is to be controlled is decided based on the instability-causing condition. For instance, in case of a reduced amount of ink in the cartridge, the movement parameter to be controlled may be acceleration, while for an absence of the cartridge on the print carriage 104, the movement parameter to be controlled may be the derivative gain, as will be explained below.

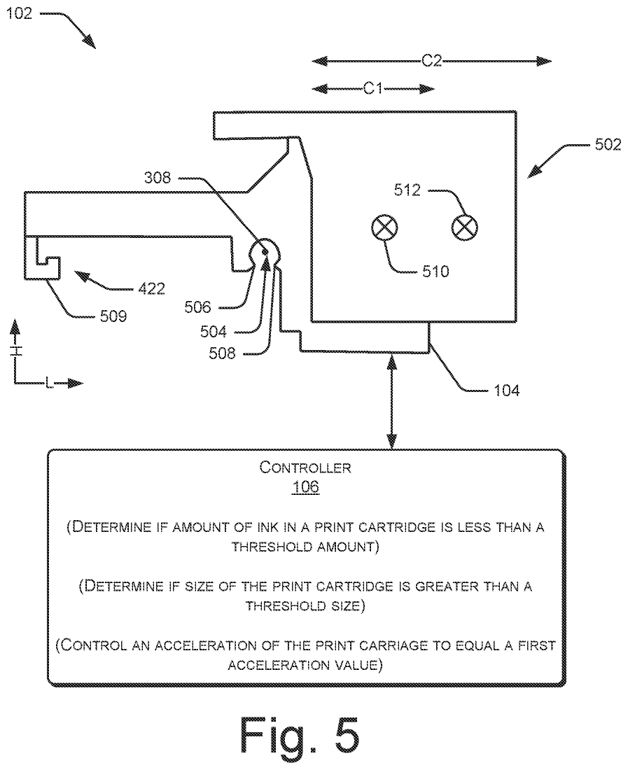

FIG. 5 illustrates a side view of the carriage unit 102, according to an example implementation of the present subject matter. The print carriage 104 may include a region 502 on its front portion having the stalls (not shown in FIG. 5), in which the cartridges (not shown in FIG. 5) can be mounted. Further, the print carriage 104 may include an opening 504 through which the print carriage 104 can be coupled to the carriage rod 302 (not shown in FIG. 5). The opening 504 may have dimensions (e.g., diameter) corresponding to that of the carriage rod 302. The print carriage 104 may also include bearings 506 and 508 that are coupled to a surface of the print carriage 104 and are projecting towards the opening 504 and towards each other. The bearings 506 and 508 may rotatably support the print carriage 104 on the carriage rod 302. Although two bearings are shown; in other examples; less or more number of bearings may be utilized. In an example, in addition to the bearings 506 and 508, two additional bearings may be utilized. The two additional bearings may be displaced from the bearings 506 and 508 in the width direction ‘W’ (not shown in FIG. 5) of the printing device 100. As mentioned earlier, the print carriage 104 may extend rearwards in the length direction ‘L’ for being supported by the backbone member 420 (not shown in FIG. 5) at its end 422. In an example, the end 422 may have a hook-like structure 509, also referred to as a hook 509, that may engage with the backbone member 420. The engagement of the hook 509 with the backbone member 420 may prevent excessive rotation of the print carriage 104 about the carriage rod 302.

A cartridge disposed on the print carriage 104 may extend along the height ‘H’ direction, the width ‘W’ direction, and the length ‘L’ direction of the printing device 100. A center of gravity of the carriage unit 102 may depend on a size of the cartridge, such as a length of the cartridge, a width of the cartridge, and a height of the cartridge. Hereinafter, the size of the cartridge may be explained with reference to the length of the cartridge. In an example, a length of the cartridge may be C1 Further, the center of gravity of the carriage unit 102 may be a point 510. In some cases, a cartridge of length longer than C1 may be disposed on the print carriage 104. For instance, the length of the cartridge may be C2. A cartridge of a longer length may be utilized because such a cartridge may accommodate more amount of ink as compared to a cartridge of shorter length, provided the other dimensions of the two cartridges are the same. A cartridge of a shorter length may be referred to as a short-body cartridge and a cartridge of longer length may be referred to as a long-body cartridge. In an example, a long-body cartridge may have a length (C2) of 64 mm and a short-body cartridge may have a length (C1) of 48 mm.

An increased length of the cartridge causes the center of gravity of the carriage unit 102 to be different than that in the case of a short-body cartridge. For instance, the center of gravity in the case of a long-body cartridge may be a point 512. As illustrated, the center of gravity in the case of the long-body cartridge is farther from the carriage axis 308 as compared to that in the case of the short-body cartridge.

The movement of the center of gravity away from the carriage axis 308 may result in an increase in a moment of force experienced by the bearings 506 and 508 when a force is exerted on the carriage unit 102 for its movement on the carriage rod 302. This is because, the force exerted on the carriage unit 102 acts on the center of gravity of the carriage unit 102 and a moment of force experienced by the bearings 506 and 508 is a product of the force and a distance between the center of gravity and the carriage axis 308. Since the distance between the center of gravity and the bearings is greater for a long-body cartridge as compared to a short-body cartridge, the moment experienced by the bearings is larger when the long-body cartridge is disposed on the print carriage 104. The force to move the carriage unit 102 on the carriage rod 302 may be exerted by the carriage motor 410 (not shown in FIG. 5) through the endless belt 414 (not shown in FIG. 5).

The increased moment may tend to move the carriage unit 102 in the length direction ‘L’, the width direction ‘W’, or both. For instance, the increased moment may tend to rotate the carriage unit 102 in the L-W plane. Such a moment causes vibrations of the carriage unit 102 when it travels on the carriage rod 302, which results in an unstable motion. In some cases, an amplitude of the vibrations increases as the mass of the carriage unit 102 decreases. This is because, with a decrease in the mass of the carriage unit 102, a weight of the carriage unit 102 decreases. The decrease in the weight of the carriage unit 102, in turn, causes a reduction in contact force exerted by the bearings on the carriage unit 102, which has a magnitude dependent on the weight and which acts against the weight. The decrease in the contact force reduces a moment of the contact force, which acts against the moment of the force moving the carriage unit 102. The mass of the carriage unit 102 may decrease due to dispensing of ink from the cartridge for printing purposes.

To prevent the unstable motion of the carriage unit 102, the controller 106 may monitor the amount of ink in the cartridge, as the amount of ink in the cartridge is indicative of the mass of the ink in the cartridge and therefore, the mass of the carriage unit 102. To determine the amount of ink in the cartridge, in an example, the controller 106 may receive a corresponding input from an ink level sensor (not shown in FIG. 5) in the cartridge. In another example, the controller 106 may determine the amount of ink in the cartridge based on the amount of ink in the cartridge when the cartridge was full (i.e., when no ink drops were dispensed) and the number of drops of ink dispensed so far. The controller 106 may also estimate the mass of the cartridge based on the amount of ink in the cartridge. To estimate the mass, a mass of a full cartridge and a mass of an empty cartridge may be utilized. The masses of a full cartridge and an empty cartridge may be pre-stored in the memory of the printing device 100.

In an example, the controller 106 may determine that the movement of the carriage unit 102 is likely to be unstable if the amount of ink in the cartridge satisfies a threshold amount. For instance, the controller 106 may determine that the movement of the carriage unit 102 is likely to be unstable if the amount of ink in the cartridge is less than a threshold amount, such as 10% of maximum amount of ink that can be stored in the cartridge. In another example, the controller 106 may determine that the movement of the carriage unit 102 is likely to be unstable if the mass of ink in the cartridge satisfies a threshold mass. For instance, the controller 106 may determine that the movement of the carriage unit 102 is likely to be unstable if the mass of ink in the cartridge is less than a threshold mass, such as 10% of maximum ink mass in the cartridge. The threshold amount (or mass) may be pre-configured in the printing device 100. For instance, the threshold amount (or mass) may be stored in the memory of the printing device 100. The stored value may be fetched by the controller 106 for performing the determination that the movement is likely to be unstable. The threshold amount (or mass) may have been determined, for example, by the manufacturer of the printing device 100, by observing vibrations encountered for a plurality of amounts of ink in the cartridge.

In an example, the controller 106 may determine that the movement is likely to be unstable if two conditions are satisfied: (i) the amount (or mass) of ink satisfies the threshold amount (or mass) and (ii) the size of the cartridge satisfies a threshold size. For instance, the controller 106 may determine that the movement is likely to be unstable if: (i) the amount (or mass) of ink is less than the threshold amount (or mass) and (ii) the length of the cartridge is greater than a threshold length (as a greater length of the cartridge causes an increase in the moment of force experienced by the bearings). In an example, the threshold length may be the length of the short-body cartridge. Although the estimation of amount (or mass) of ink in the cartridge is explained as being performed by the controller 106, in an example, the controller 106 may receive the value of amount (or mass) from another entity, such as a PCA, in the printing device 100. Further, the controller 106 may determine that the length of the cartridge is greater than the threshold length based on an identifier of the cartridge, as an identifier of a short-body cartridge is different than that of a long-body cartridge.

To prevent the instability arising out of a reduced amount of ink in the cartridge, in an example, the controller 106 may determine that the acceleration of the carriage unit 102 is to be less than the acceleration to be utilized for an ink amount more than the threshold amount. A reduced acceleration may have to be utilized because a reduced acceleration reduces a force exerted on the carriage unit 102 for its movement on the carriage rod 302 (as force is dependent on the acceleration). The reduced force, in turn, reduces the moment of the force, thereby preventing vibrations, and unstable movement. The reduced acceleration value, at which the carriage unit 102 accelerates on the carriage rod 302 to prevent unstable movement, may be referred to as the first acceleration value. Further, the acceleration value to be utilized for an ink amount more than the threshold amount may be referred to as a second acceleration value, which is more than the first acceleration value. In an example, the second acceleration value may be g m/s² and the first acceleration value is 0.8 *g m/s², where g is the acceleration due to gravity. The reduced acceleration value may be predetermined, and may have been determined by observing vibrations encountered for a plurality of values of acceleration. Upon determining that the carriage unit 102 is to be accelerated at the first acceleration value, when the carriage unit 102 is to be moved, the carriage unit 102 is accelerated at the first acceleration value.

In an example, the controller 106 may allow the carriage unit 102 to accelerate when the carriage unit 102 starts moving from one end of the carriage rod 302 and until the carriage unit 102 reaches a first predetermined position on the carriage rod 302. Upon reaching the first predetermined position, the acceleration of the carriage unit 102 may be brought down to zero, and the carriage unit 102 may be allowed to travel at a uniform speed on the carriage rod 302. When the carriage unit 102 reaches a second predetermined position on the carriage rod 302, the carriage unit 102 may be decelerated, so that the speed of the carriage unit 102 drops to zero by the time it reaches the other end of the carriage rod 302. In an example, the deceleration value may be a negative value of the first acceleration value. The first predetermined position and the second predetermined position may be determined based on a maximum speed at which the carriage unit 102 should be allowed to travel on the carriage rod 302.

If the controller 106 determines that the movement of the carriage unit 102 is likely to be stable, such as due to the amount of ink being above the threshold amount, the controller 106 may determine that the second acceleration value is to be associated with the movement of the carriage unit 102. Thereafter, the controller 106 may control the acceleration of the carriage unit 102 to equal the second acceleration value. Further, the controller 106 may allow the carriage unit 102 to accelerate until the maximum speed is reached and thereafter, reduce the acceleration to zero. The controller 106 may also cause deceleration of the carriage unit 102 at a negative value of the second acceleration value, so that the carriage unit 102 becomes stationary upon reaching the other end of the carriage rod 302.

Although in the above examples, the detection of instability is exampled with reference to the length of the cartridge, in some examples, the instability may be determined based on other dimensions of the cartridge, such as a width or a height of the cartridge. This is because, in some cases, an increased width or height (e.g., greater than a threshold width or a threshold height) may also cause the center of gravity of the carriage unit 102 to move away from the carriage rod 302. Accordingly, in addition to the amount of ink in the cartridge, the width or height of the cartridge may also be used to forecast an instability.

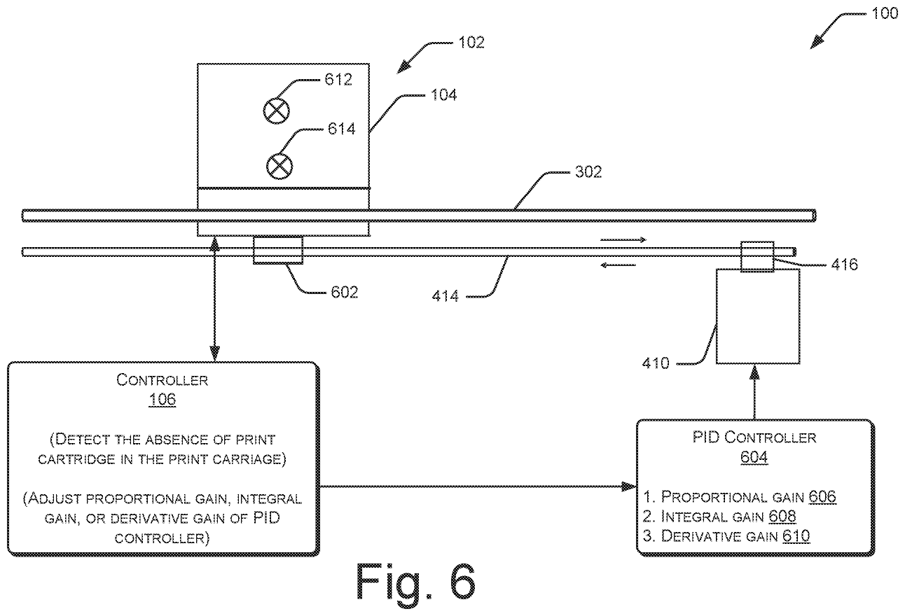

FIG. 6 illustrates a schematic view of the printing device 100, according to an example implementation of the present subject matter. The print carriage 104 may be coupled to the endless belt 414 through a belt attachment coupler 602 of the printing device 100. The coupling of the print carriage 104 with the endless belt 414 causes movement of the print carriage 104 along the carriage rod 302 when the carriage motor 410 is rotated, as explained earlier.

In an example, the carriage motor 410 is controlled by a control system (not shown in FIG. 6). The control system may include, for example, a proportional-integral-derivative (PID) controller 604. Although the PID controller 604 is shown separately from the controller 106, in an example, the PID controller 604 may be implemented as a part of the controller 106. The PID controller 604 may receive information regarding position of the print carriage 104 on the carriage rod 302, for example, from the encoder strip 418 (not shown in FIG. 6) and may control speed, acceleration, or both of the print carriage 104 based on commanded values of speed, acceleration, or both respectively. For instance, the PID controller 604 may receive the actual values of the speed and/or acceleration as a feedback and compare them with their respective commanded values. The commanded values may be, for example, stored in the memory of the printing device 100. An error signal may then be generated based on the comparison. Such an error signal may be used for correction of the actual values based on a proportional gain 606, an integral gain 608, and a derivative gain 610 of the PID controller 604.

When the carriage motor 410 starts rotating, a phenomenon known as cogging may occur, which involves a magnetic locking between magnetic components in a rotor of the carriage motor 410 and magnetic components in a stator (not shown in FIG. 6) of the carriage motor 410. The cogging phenomenon may cause ripples in the speed of the carriage motor 410. Generally, the ripples in the speed of the carriage motor 410 do not translate into vibrations of the print carriage 104 because the ripples are damped out by the endless belt 414. However, the endless belt 414 may not damp out the ripples if it has a low weight or a high stiffness. In some cases, the amplitude of the vibrations may increase as the weight of the carriage unit 102 decreases due to reduction in contact force exerted by the bearings, as explained earlier. Further, the amplitude of the vibrations may be significant if no cartridge is disposed on the print carriage 104, and may give rise to an objectionable noise. The carriage unit 102 may travel on the carriage rod 302 without the cartridge, for example, when the printing device 100 is newly installed at premises of a user and is tested for proper functioning.

One possible reason for a high amplitude of the vibrations in the absence of the cartridge is that, in the absence of the cartridge, the center of gravity of the carriage unit 102 is closer to carriage rod 302 as compared to a case where the cartridge is disposed on the print carriage 104. For instance, the center of gravity when the cartridge is present on the print carriage 104 may be a point 612, while, in the absence of the cartridge, the center of gravity may be a point 614. The closeness of the center of gravity to the carriage rod 302 may bring a natural frequency of the carriage unit 102 closer to the frequency of ripples in the speed of the carriage motor 410. Therefore, the carriage unit 102 may resonate with the ripples. Accordingly, the movement of the carriage unit 102 on the carriage rod 302 may become an unstable one.

To prevent the movement of the carriage unit 102 from being an unstable one, the controller 106 may check for the presence of the cartridge on the print carriage 104. If the cartridge is absent on the print carriage, the controller 106 may determine that a first correction factor value is to be adjusted. In an example, the first correction factor may be the derivative gain 610 of the PID controller 604. For instance, in the absence of the cartridge, the controller 106 may determine that the derivative gain 610 may have to be set at a first derivative gain value that is less than that utilized when the cartridge is present. The derivative gain value utilized when the cartridge is present may be referred to as a second derivative gain value.

The derivative gain value may have to be reduced because a reduced derivative gain value may prevent amplification of speed ripples of the carriage motor 410, which, in turn, facilitates damping of the vibrations caused by the togging. In an example, the first derivative gain value may be 0.35, while the second derivative gain value may be 0.5. The first derivative gain value may have been determined based on vibrations observed for a plurality of the derivative gain values.

Although the first correction factor is explained as the derivative gain 610, in other examples, the first correction factor may be the proportional gain 606 or the integral gain 608. Accordingly, the first correction factor value may be a first proportional gain value or a first integral value. Further, in some examples, more than one of the proportional gain 606, the integral gain 608, and the derivative gain 610 may be controlled in the absence of the cartridge, to prevent instability. Further, although the control system is explained with reference to a PID controller, in some examples, other types of controller, such as a PI controller, a PD controller, or a lead-lag compensator may be utilized in the control system. Overall, any control system that can adjust its control parameters to prevent amplification of the speed ripples of the carriage motor 410 can be utilized.

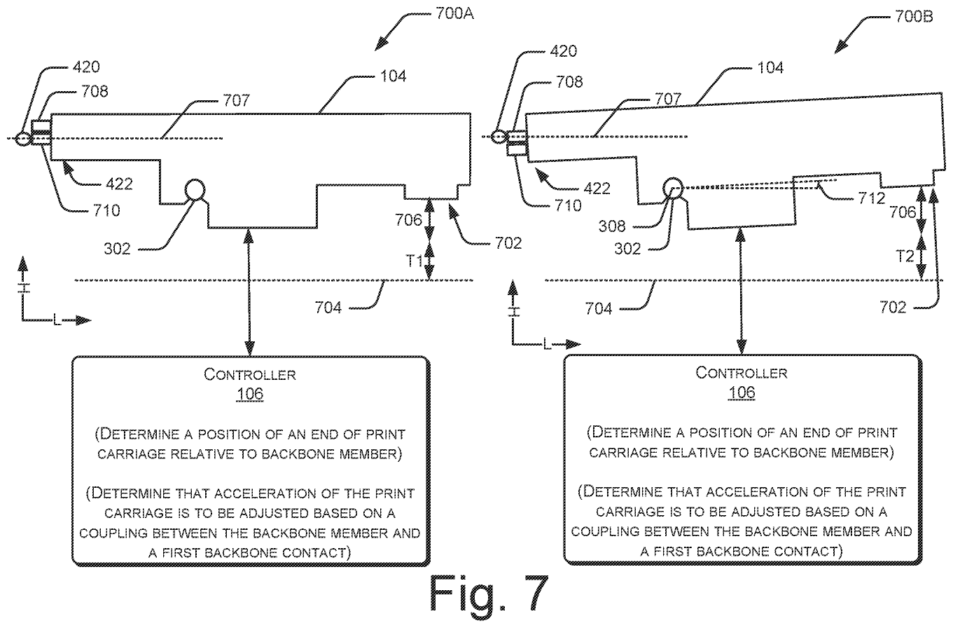

FIG. 7 illustrates the print carriage 104 having different angular orientations relative to the carriage rod 302, according to an example implementation of the present subject matter. The print carriage 104 includes the end 422 (hereinafter referred to as “the first end 422”) and a second end 702 opposite the first end 422. The second end 702 may be an end of the print carriage 104 that is proximate the cartridge (not shown in FIG. 7) and may be referred to as a front side of the print carriage 104.

A line 704 indicates the height at which a lower surface of a printable medium (not shown in FIG. 7) to be printed on is disposed in the printing device 100. A distance 706 between an upper surface of the printable medium and the second end 702 may depend on a thickness of the printable medium. For instance, the scenario illustrated on section 700A of FIG. 7 (hereinafter referred to as “the first scenario′) may correspond to a printable medium of lower thickness (T1), such as a sheet of paper. Contrarily, the scenario illustrated on section 700B of FIG. 7 (hereinafter referred to as the second scenario”) may correspond to a printable medium of higher thickness (T2), such as an envelope. A distance 706 may be referred to as a cartridge-to-media spacing or, more generally, as a pen-to-paper spacing (PPS). The PPS may have to be maintained at a substantially constant value regardless of the thickness of the printable medium, as a low PPS may cause jamming of the printable medium.

To maintain the PPS at a substantially constant value, the print carriage 104 may have to be slightly rotated about the carriage axis 308. For instance, to maintain the PPS for a thicker printable medium, the print carriage 104 illustrated in the section 700A may be rotated in an anti-clockwise direction. The rotated print carriage 104 is the print carriage 104 illustrated in the section 700B. The scenario of the section 700A may be referred to as a stage-1 PPS and the scenario of the section 700B may be referred to as a stage-2 PPS.

The rotation of the print carriage 104 about the carriage axis 308 may be facilitated by adjusting a position of the first end 422 relative to the backbone member 420. The backbone member 420 remains stationary and does not change in height, as illustrated by line 707, which is at the same height in both the sections. To adjust the relative position of the first end 422, in an example, the print carriage 104 may include a first backbone contact 708 and a second backbone contact 710, each of which is disposed at the first end 422. The second backbone contact 710 may be disposed below the first backbone contact 708, for example, in the height direction ‘H’ of the printing device 100.

The first end 422 may be coupled to the backbone member 420 through either the first backbone contact 708 or the second backbone contact 710. The backbone contact through which the first end 422 is coupled to the backbone member 420 may determine the distance between the second end 702 and the line 704. Since the first backbone contact 708 is disposed at a greater height than the second backbone contact 710, the coupling of the first end 422 to the backbone member 420 through the first backbone contact 708 (as illustrated in the section 700B) causes a larger distance between the second end 702 and the line 704 as compared to the coupling through the first backbone contact 708 (as illustrated in the section 700A). Accordingly, if a thicker media, such as an envelope, is to be printed on, the first end 422 may be coupled to the backbone member 420 through the first backbone contact 708. Contrarily, if a thin media, such as a sheet of paper, is to be printed on, the coupling may be effected through the second backbone contact 710. The backbone contact through which the first end 422 is coupled to the backbone member 420 may be changed using a linear cam or a rotary cam (not shown in FIG. 7).

The rotation of the print carriage 104 and the disposition of the print carriage 104 in a position illustrated in the second scenario causes the print carriage 104 to be inclined relative to the carriage axis 308. For instance, the print carriage 104 may be disposed at an angle 712 relative to the carriage axis 308. The inclination of the print carriage 104 may cause an imbalance in the forces and moments acting on the print carriage 104. The imbalance may cause an unstable movement of the print carriage 104 on the carriage rod 302.

To prevent the unstable motion arising out of the change in orientation of the print carriage 104 relative to the carriage axis 308, in an example, the controller 106 may identify a position of the first end 422 relative to the backbone member 420. The controller 106 may perform the identification based on the backbone contact that is coupled to the backbone member 420. If the controller 106 determines that the first end 422 is coupled through the first backbone contact 708, the controller 106 may determine that the movement of the print carriage 104 on the carriage rod 302 is likely to be unstable. To prevent the unstable movement, the controller 106 may determine that the acceleration of the print carriage 104 is to be controlled to a first acceleration value. The first acceleration value may be less than a second acceleration value, which may be the acceleration value corresponding to the first scenario (where coupling is achieved through the second backbone contact 710).

In an example, the first acceleration value utilized to prevent instability caused by change in the orientation of the print carriage 104 may be different from that utilized to prevent instability caused by a reduced amount of ink in the cartridge. Accordingly, the controller 106, upon detecting an instability-causing condition, may control the acceleration to an acceleration value corresponding to that condition. In an example, the first acceleration value may be 1.2 *g m/s², while the second acceleration value may be 1.4 *g m/s².

The control of the acceleration to a lower value compensates for the force imbalance, the moment imbalance, or both caused by the inclination of the print carriage 104. Therefore, the unstable movement of the print carriage 104 may be prevented. Further, by utilizing the reduced acceleration value for the stage-2 PPS and not for the stage-1 PPS, the present subject matter prevents operating the print carriage 104 at reduced acceleration for stage-1 PPS. Accordingly, the print carriage 104 can be operated at a high acceleration and speed for stage-1 PPS, thereby facilitating improvement in the throughput (i.e., the number of sheets of printable media printed per unit time) of the printing device 100.

The present subject matter controls a movement of the print carriage to provide a stable movement of the print carriage in a printing device. The stable movement of the print carriage results in an improved print quality. The stable movement also prevents damage to the bearings that rotatably support the print carriage, thereby improving the life of the bearings. The present subject matter also reduces the noise generated by the printing device during its operation, as vibrations of the print carriage are prevented. Therefore, acoustics of the printing device are improved.

The present subject matter prevents the use of additional or more expensive components to ensure a stable movement of the print carriage. For instance, the present subject matter facilitates utilizing long-body cartridges in printing devices without changing the design of carriage rods. Further, a stable movement of the print carriage can be achieved even when a belt with high stiffness or low weight is utilized and even when a carriage motor experiencing significant amount of cogging is utilized. Thus, any of a wide range of belts and carriage motors may be utilized in the printing devices without impacting stability of the print carriage. Therefore, a stable movement of the print carriage can be achieved in a simple and a cost-effective manner.

Further, since reduced acceleration values and correction factor values are utilized for specific conditions, the present subject matter facilitates utilizing increased values of acceleration and correction factor in the absence of such conditions. This improves speed of the print carriage and throughput of the printing device.

Although examples and implementations of present subject matter have been described in language specific to structural features and/or methods, it is to be understood that the present subject matter is not necessarily limited to the specific features or methods described. Rather, the specific features and methods are disclosed and explained in the context of a few example implementations of the present subject matter. Furthermore, as thresholds are described; values that are less than or exceed the threshold may be considered also satisfied when equal to the threshold in various examples.

What is claimed is:

1. A printing device comprising:
a supporting member;
a carriage unit movably mounted on the supporting member and comprising a print carriage that is to house a print cartridge; and
a controller to:
determine that a movement of the carriage unit on the supporting member is likely to be unstable based on a mass of fluid in the print cartridge, absence of the print cartridge on the print carriage, or an orientation of the carriage unit relative to the supporting member;
determine that a first movement parameter value is to be associated with movement of the carriage unit on the supporting member to prevent unstable movement, wherein the first movement parameter value is a first acceleration value or a first correction factor value; and
control the movement of the carriage unit based on the first movement parameter value.

2. The printing device of claim 1, wherein the carriage unit comprises the print cartridge and wherein the controller is to determine that the movement of the carriage unit on the supporting member is likely to be unstable in response to the mass of fluid in the print cartridge satisfying a threshold mass.

3. The printing device of claim 2, wherein the controller is to determine that the movement of the carriage unit on the supporting member is likely to be unstable in response to a size of the print cartridge satisfying a threshold size.

4. The printing device of claim 1, comprising a carriage motor to drive the carriage unit, wherein the first correction factor value is a first derivative gain value, a first integral gain value, or a first proportional gain value, of a control system that is to control the movement of the carriage unit.

5. The printing device of claim 1, comprising:
a backbone member, wherein a first end of the print carriage is coupled to the backbone member, wherein a position of the first end relative to the backbone member is adjustable, and wherein, to determine the orientation of the carriage unit relative to the supporting member, the controller is to:
determine the position of the first end relative to the backbone member.

6. The printing device of claim 5, wherein the print carriage comprises:
a first backbone contact disposed at the first end of the print carriage and being couplable to the backbone member; and
a second backbone contact disposed at the first end of the print carriage and being couplable to the backbone member, wherein the second backbone contact is disposed below the first backbone contact at the first end and wherein the controller is to determine that the movement of the carriage unit on the supporting member is likely to be unstable in response to the first end being coupled to the backbone member through the first backbone contact.

7. The printing device of claim 1, wherein, in response to a determination that the movement of the carriage unit on the supporting member is likely to be stable, the controller is to:
determine that a second movement parameter value is to be associated with the movement of the carriage unit on the supporting member, wherein the second movement parameter value is:
a second acceleration value greater than the first acceleration value; or
a second correction factor value greater than the first correction factor value; and
control the movement of the carriage unit based on the second movement parameter value.

8. A printing device comprising:
a carriage unit movably mounted in the printing device and comprising a print carriage: and
a controller to:
determine that a weight of the carriage unit is insufficient to cause a stable movement of the carriage unit;
determine that a first movement parameter value is to be associated with movement of the carriage unit to cause a stable movement, wherein the first movement parameter value comprises a first acceleration value or a first correction factor value; and
control the movement of the carriage unit based on the first movement parameter value.

9. The printing device of claim 8, wherein the controller is to determine that the weight of the carriage unit is insufficient to cause a stable movement in response to absence of a print cartridge on the print carriage.

10. The printing device of claim 9, comprising:
a carriage motor to drive the carriage unit; and
a control system comprising a proportional-integral-derivative (PID) controller to control movement of the carriage motor; wherein the first correction factor value is a first derivative gain value of the PID controller, and wherein, in response to the absence of the print cartridge on the print carriage, the controller is to:
set the first derivative gain value as a derivative gain of the PID controller.

11. The printing device of claim 8, wherein the carriage unit comprises a print cartridge disposed on the print carriage, and wherein the controller is to determine that the weight of the carriage unit is insufficient to cause a stable movement in response to an amount of ink in the print cartridge satisfying a threshold amount.

12. A printing device comprising:
a carriage rod;
a print carriage slidably mounted on the carriage rod;
a print cartridge disposed on the print carriage; and
a controller to:
determine that a movement of the print carriage on the carriage rod is likely to be unstable based on an amount of fluid in the print cartridge or an orientation of the print carriage relative to an axis of the carriage rod;
in response to the determination, identify an acceleration value at which the print carriage is to accelerate on the carriage rod, to prevent unstable movement; and
control an acceleration of the print carriage to equal the identified acceleration value.

13. The printing device of claim 12, wherein the controller is to determine that the movement of the print carriage is likely to be unstable in response to the amount of fluid in the print cartridge satisfying a threshold amount.

14. The printing device of claim 13, wherein the controller is to determine that the movement of the print carriage is likely to be unstable in response to a length of the print cartridge satisfying a threshold length.

15. The printing device of claim 12, comprising:
a backbone member parallel to the carriage rod, wherein print carriage comprises:
a first backbone contact disposed on a first end of the print carriage; and
a second backbone contact disposed on the first end of the print carriage and below the first backbone contact, wherein the print carriage is couplable to the backbone member through the first backbone contact or the second backbone contact, and wherein the controller is to:
determine the orientation of the print carriage relative to the axis of the carriage rod based on a backbone contact through which the print carriage is coupled to the backbone member.
